(19) United States
(12) Patent Application Publication
(10) Pub. No.: US 2015/0093566 A1
(43) Pub. Date: Apr. 2, 2015

(54) WEAR RESISTANT COATING

(71) Applicant: Diapac LLC, Houston, TX (US)

(72) Inventor: Andrew BELL, Forthampton (GB)

(21) Appl. No.: 14/504,212

(22) Filed: Oct. 1, 2014

Related U.S. Application Data
(60) Provisional application No. 61/885,714, filed on Oct. 2, 2013.
(60) Provisional application No. 61/987,541, filed on May 2, 2014.

(51) Int. Cl. B05D 1/10; B05D 1/36; B05D 1/12

(52) U.S. Cl. CPC B05D 1/10; B05D 1/12; B05D 1/36
USPC 428/323; 427/203; 427/446; 427/569; 106/12

(57) ABSTRACT

A wear resistant coating and a method of forming a wear resistant coating on a substrate. The method includes applying a plurality of round particles to the substrate, each of the plurality of round particles including a round outer layer encapsulating a wear resistant element. The method comprises applying a wear resistant coating binder to the substrate. The method includes heating the plurality of round particles and the wear resistant coating binder.

### RELATED APPLICATIONS

The present application claims priority to U.S. Provisional Patent Application No. 61/885,714, filed Oct. 2, 2013, and U.S. Provisional Patent Application No. 61/987,541, filed May 2, 2014, the disclosures of which are hereby incorporated by reference herein in their entirety.

### TECHNICAL FIELD

The disclosure herein generally but not exclusively relates to a hardfacing powder for forming a wear resistant coating on a substrate, a method for making a hardfacing powder for forming a wear resistant coating on a substrate, a wear resisting coating on a substrate, and a method for forming a wear resistant coating on a substrate.

### BACKGROUND

Hardfacing is a process of forming a wear resistant coating on a surface to improve the wear properties of the surface or repair the surface. Hardfacing is currently used in relation to industrial, excavation and drilling tools, for example.

Generally, there is a long felt need for better, harder and more consistent wear resistant coatings that can be formed relatively easily.

### SUMMARY

Disclosed herein is a method of forming a wear resistant coating on a substrate, the method comprising the steps of:

applying a plurality of round particles to the substrate, each of the plurality of round particles comprising a round outer layer encapsulating a wear resistant element;

applying a wear resistant coating binder to the substrate; and

heating the plurality of round particles and the wear resistant coating binder.

An embodiment comprises the step of metallurgically bonding the wear resistant coating binder to at least one of an inner surface and an outer surface of the round outer layer of each of the plurality of round particles.

In an embodiment, the wear resistant coating binder comprising metallic binding material and the metallic binding material is melted to form a monolithic matrix of metallic binding material.

An embodiment comprises the step of the metallic binding material so melted penetrating the round outer layer of each of the plurality of round particles.

In an embodiment, the wear resistant element of each of the plurality of round particles has a coating metallurgically bonded thereto, and the coating is metallurgically bonded with the wear resistant coating binder.

An embodiment comprises the step of the binding material penetrating the round outer layer of each of the plurality of round particles and forming a metallurgical bond with the coating.

Generally, the round outer layer of each of the plurality of round particles controls the spacing and/or the packing of the wear resistant elements of the plurality of round particles within the wear resistant coating when formed. Consequently, the thickness of the round outer layer may be chosen to control the number of wear resistant elements per unit volume of the wear resistant coating. The thickness of the round outer layer may be chosen to control the wear resistant element's uniformity of distribution within the wear resistant coating.

In an embodiment, the step of heating may generally cause the wear resistant coating binder to bind the plurality of round particles. The heating may be at least one of during and after application of the wear resistant coating binder and the plurality of round particles. For example, the step of heating may comprise the step of heating the plurality of round particles so applied to the substrate and heating the wear resistant coating binder so applied to the substrate.

In an embodiment, the step of applying the plurality of round particles to the substrate comprises the step of introducing the plurality of round particles into a flame directed at the substrate. The flame may heat the plurality of round particles. The step of applying a wear resistant coating binder to the substrate may comprise the step of introducing the wear resistant coating binder into the flame directed at the substrate. The flame may heat the wear resistant coating binder. The plurality of round particles and the wear resistant coating binder may be, but not necessarily, introduced separately into the flame.

An embodiment comprises the step of introducing a mixture comprising the plurality of round particles and the wear resistant coating binder into a flame directed at the substrate. The flame may heat the plurality of round particles and the wear resistant coating binder.

In an embodiment, the flame heats the plurality of round particles and the wear resistant coating binder above an adhesion temperature.

In an embodiment, the flame is generated by a high velocity oxygen-fuel deposition torch.

An embodiment comprises applying the plurality of round particles and a wear resistant coating binder to the substrate by introducing the plurality of round particles and the wear resistant coating binder into a plasma stream directed at the substrate, the plasma stream heating the wear resistant coating binder and the plurality of round particles.

In an embodiment, the plasma stream heats the wear resistance coating binder to a temperature greater than at least one of a wear resistant coating binder softening temperature and a wear resistant coating binder melting temperature.

An embodiment comprises the step of introducing a mixture comprising the plurality of round particles and the wear resistant coating binder into a plasma stream directed at the substrate.

In an embodiment, the plurality of round particles and the wear resistant coating binder are separately introduced into a plasma stream directed at the substrate.

In an embodiment, the plurality of round particles and the wear resistant coating binder are deposited onto a melted portion of the substrate outside of a plasma stream that heated the melted portion. The melted portion of the substrate may heat the plurality of round particles and the wear resistant coating binder.

In an embodiment, the melted portion of the substrate heats the wear resistant coating binder to a temperature greater than at least one of a wear resistant coating binder softening temperature and a wear resistant coating binder melting temperature.

In an embodiment, the plurality of round particles and the wear resistant coating binder are separated from the plasma stream by a separator. The separator may comprises a separating structure. The separator may comprise a separating wall.

In an embodiment, the plasma stream is moved across a surface of the substrate and a source of the plurality of round particles and a source of the wear resistant coating binder follow the plasma stream. The plasma stream may be moved across a surface of the substrate and a source of the plurality of round particles and the wear resistant coating binder follow the plasma stream.

An embodiment comprises the step of delivering a shielding gas around the plasma stream.

In an embodiment, the wear resistant coating binder comprises a plurality of metallic particles.

In an embodiment, the wear resistant element comprises cubic boron nitride.

In an embodiment, the plurality of round particles has a close packed arrangement once so applied to the substrate.

Disclosed herein is a hardfacing powder for forming a wear resistant coating on a substrate. The hardfacing powder comprises a plurality of round particles, and a wear resistant coating binder for binding the plurality of round particles in the wear resistant coating when formed. Each of the plurality of round particles comprises a round outer layer encapsulating a wear resistant element.

In an embodiment, for each of the plurality of round particles the round outer layer has a density greater than that of the wear resistant element. The wear resistant coating binder is generally molten during formation of the wear resistant coating. The plurality of round particles are less buoyant in molten wear resistant coating binder than a plurality of wear resistant elements free of the round outer coatings. The distribution of the elements in the wear resistant coating may be consequently better than if the round outer layers were absent.

In an embodiment, the wear resistant coating binder may comprise a plurality of metallic particles. The plurality of metallic particles may comprise a braze metal. The braze metal may comprise a braze alloy.

In an embodiment, the volume fraction of the plurality of round particles is at least 0.05. The volume fraction of the plurality of round particles may be no more than 0.85.

In an embodiment, the wear resistant element of each of the plurality of round particles has an ISO 6106 mesh size of at least 18. The wear resistant element of each of the plurality of round particles may have an ISO 6106 mesh size of no more than 120. In an alternative embodiment, the wear resistant element of each of the plurality of round particles may have an ISO 6106 mesh size of no more than 80.

In an embodiment, the round outer layer comprises a composite material. The composite material may be a cermet. The cermet may be a polycrystalline cermet.

In an embodiment, the wear resistant element of each of the plurality of round particles comprises a material having a Vickers hardness greater than at least one of 20 GPa and 40 GPa. Wear resistant elements having a Vickers hardness of greater than 40 GPa are, in the context of this document, super hard materials.

In an embodiment, each of the plurality of round particles has an elastic modulus of greater than 200 GPa.

In an embodiment, the wear resistant element of each of the plurality of round particles has a coating metallurgically bonded thereto, the coating being metallurgically bondable to the wear resistant coating binder.

An embodiment comprises the step of the binding material penetrating the round outer layer of each of the plurality of round particles and forming a metallurgical bond with the coating. A third aspect of the invention provides a method for making a hardfacing powder for forming a wear resistant coating on a substrate. The method comprises the step of combining a plurality of round particles and a wear resistant coating binder. Each of the plurality of round particles comprises a round outer layer encapsulating a wear resistant element.

In an embodiment, for each of the plurality of round particles the round outer layer has a density greater than that of the wear resistant element.

In an embodiment, the wear resistant coating binder may comprise a plurality of metallic particles. The plurality of metallic particles may comprise a braze metal. The braze metal may comprise a braze alloy.

In an embodiment, the volume fraction of the plurality of round particles within the mixture is at least 0.05. The volume fraction of the plurality of round particles within the mixture may be no more than 0.85.

In an embodiment, the round outer layer comprises a composite. The composite may be a cermet. The cermet may be a polycrystalline cermet.

In an embodiment, the wear resistant element of each of the plurality of round particles has an ISO 6106 mesh size of at least 18. The wear resistant element of each of the plurality of round particles may have an ISO 6106 mesh size of no more than 80. The wear resistant element of each of the plurality of round particles may have an ISO 6106 mesh size of no more than 120. In an embodiment, the wear resistant element of each of the plurality of round particles comprises a material having a Vickers hardness greater than at least one of 20 GPa and 40 GPa.

In an embodiment, each of the plurality of round particles has an elastic modulus of greater than 200 GPa.

In an embodiment, the wear resistant element of each of the plurality of round particles has a coating metallurgically bonded thereto, the coating being metallurgically bondable to the wear resistant coating binder.

Disclosed herein is a wear resistant coating on a substrate. The wear resistant coating comprises a composite material comprising a plurality of round particles bound together by a wear resistant coating binder, each of the plurality of round particles comprising a round outer layer encapsulating a wear resistant element.

In an embodiment, the plurality of round particles have a close packed arrangement.

In an embodiment, the wear resistant coating comprises another plurality of particles that occupy a plurality of interstices between the plurality of round particles. The other plurality of particles may be round. The other plurality of particles may comprise a first plurality of particles having a first mean diameter and a second plurality of particles having a second mean diameter that is less than the first mean diameter. The second mean diameter may be less than 10% of the first mean diameter. The second plurality of particles may further increase the volume fraction of particles within the wear resistant coating when formed, which may improve the wear resistance of the wear resistant coating.

Disclosed herein is a wear resistant coating on a substrate, the wear resistant coating comprising:

a composite material comprising a plurality of round particles bound together by a wear resistant coating binder, wherein each of the plurality of round particles comprises a round outer layer encapsulating a wear resistant element, the wear resistant coating binder penetrates the round outer layer and is metallurgically bonded to a coating metallurgically bonded to the wear resistant element of each of the plurality of particles, wherein the wear resistant coating binder is metallurgically bonded to at least one of an inner surface and an outer surface of the round outer layer of each of the plurality of round particles.

Any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIG. 1 shows a section through an embodiment of a hardfacing powder.

FIG. 2 schematically shows a flow diagram of an embodiment of a method of making a wear resistant coating with the hardfacing powder of FIG. 1.

FIG. 3 shows a longitudinal section of an example of a torch that may be used to apply the hardfacing powder of FIG. 1.

FIGS. 4 and 5 show longitudinal sections of other examples of a torch that may be used to apply the hardfacing powder of FIG. 1.

FIG. 6 shows a cross section of a representative particle of a plurality of round particles within the powder of FIG. 1.

FIG. 7 is a back scattered scanning electron micrograph of an encapsulant.

FIG. 8 is a back scattered scanning electron micrograph of a fracture through one of the plurality of round particles.

FIG. 9 shows a plurality of round particles.

FIGS. 10-12 show schematic diagrams where interstices of a plurality of round particles are occupied with another plurality of particles.

FIG. 13 shows a micrograph of an embodiment of a wear resistant coating made by using the hardfacing powder of FIG. 1.

FIG. 14 shows a cross section through an example of a high velocity oxy-fuel deposition torch.

### DESCRIPTION OF EMBODIMENTS

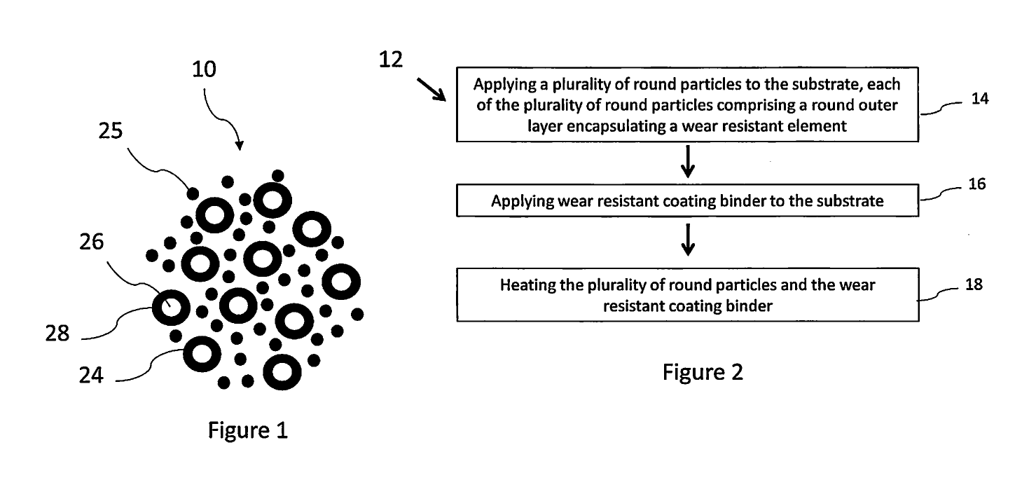

FIG. 1 shows a section through an embodiment of a hardfacing powder generally indicated by the numeral 10. The hardfacing powder 10 is for forming a wear resistant coating on a substrate. The hardfacing powder comprises a plurality of round particles 24 and a wear resistance coating binder 25 in the form of a metallic binding material for binding the plurality of round particles in the wear resistant coating when formed. In this but not necessarily in all embodiments the wear resistant coating binder comprises a plurality of wear resistant coating binder particles 25 (in the form of a plurality of metallic particles) for binding the plurality of round particles within the wear resistant coating when formed. Each of the plurality of round particles 24 comprises a round outer layer 28 encapsulating a wear resistant element 26.

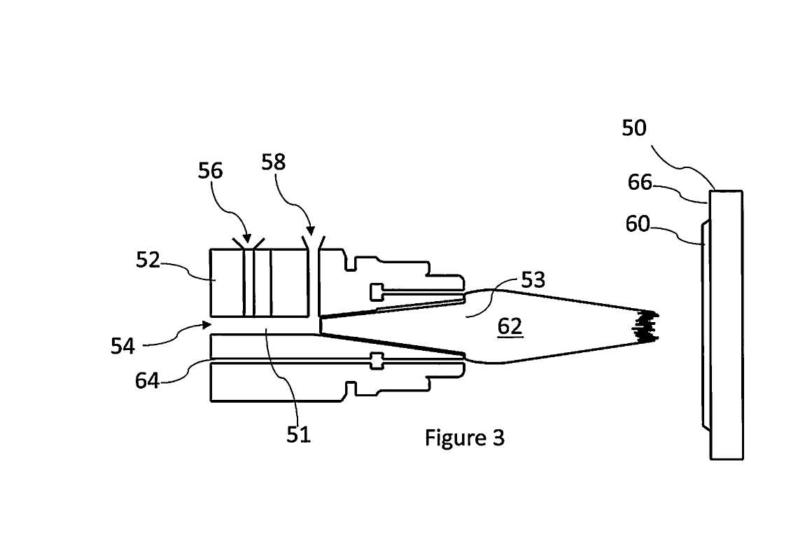

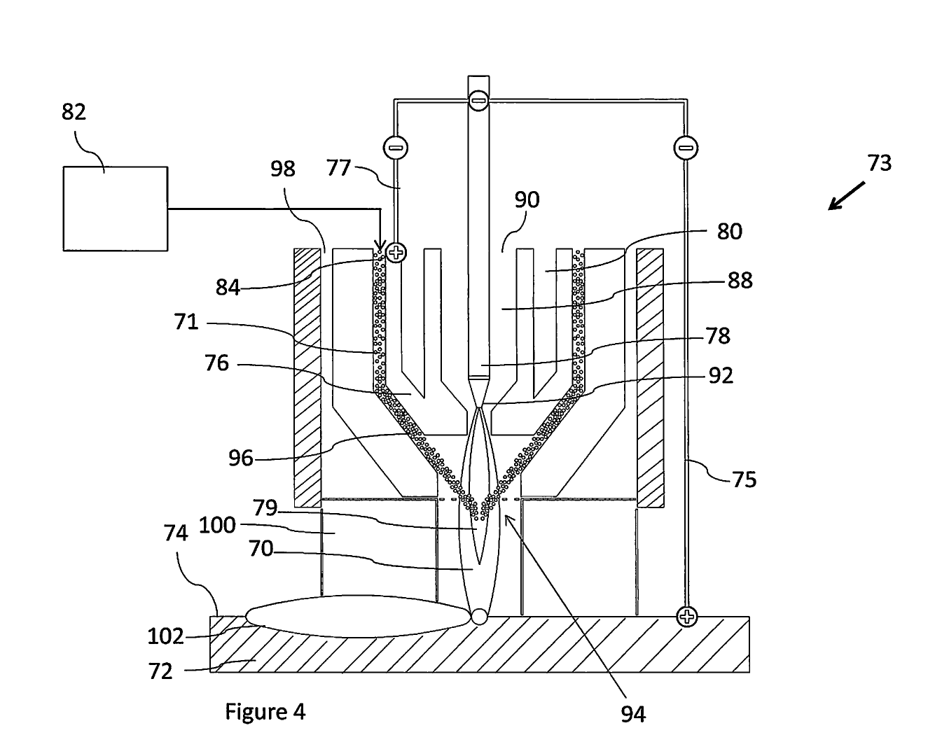

FIG. 2 shows flow diagram of an embodiment of a method 12 for forming a wear resistant coating 60 on a substrate 50. FIG. 3 shows an example of a head of an oxygen-fuel torch that may be used to apply the hardfacing power 10 to the substrate 50 in accordance with the method 12. A surface 66 of the substrate 50 is optionally cleaned by application of a grinder. Alternatively, a chemical cleaning agent, or generally any suitable cleaning process may be used. The substrate 50 may be steel or generally any substrate for which the method 12 is suitable. In this example the gaseous fuel is acetylene. Acetylene introduced into port 54 of the oxyacetylene torch 52 may travel down a conduit 51 and exit the torch head 52 at a gas conduit opening 53 where it is combusted with oxygen introduced into port 64 to form a flame in the form of an oxy-acetylene flame 62. Generally any suitable fuel may be used, examples of which include propane, hydrogen, and methane. In alternative embodiments, the oxygen may be introduced via port 54 and the acetylene may be introduced through the port 64. The flame 62 may then be optionally applied to the substrate to preheat it. The hardfacing powder 10 may be then introduced into the stream of acetylene gas in conduit 51 via either one of powder feed ports 56 and 58. Alternatively, the plurality of round particles may be introduced through port 56, and the wear resistant coating binder may be introduced via port 58. This may overcome any potential or actual problems with segregation within the hardfacing powder that may reduce wear resistant coating quality. The hardfacing powder is carried along the conduit 51 by the acetylene into the flame directed at the substrate 50 and which heats the plurality of round particles and the wear resistant coating binder to above an adhesion threshold temperature such that the plurality of round particles and wear resistant coating binder adheres to the substrate 50 when applied thereto to form a green coating, or in some alternative embodiments the wear resistant coating. The adhesion threshold temperature may generally vary according to the hardfacing powder composition. The adhesion temperature may be greater than at least one of, for example, 500° C., 600° C., 700° C., 800° C., 900° C. and 1000° C. The flow of the powder may then be stopped. The flame is then applied to the green coating (in this embodiment but not necessarily in all embodiments) with further powder in the acetylene stream) to heat it to above a wear resistant coating binder melting temperature. Consequently, the wear resistant coating binder melts to form a fluid in the form of a hardfacing powder melt. The fluid and the particles therein flow over the surface of the substrate 50. The flame is then removed from the substrate. The fluid solidifies on cooling to form a wear resistant coating 60 comprising the plurality of round particles distributed in and bound by the wear resistant coating binder. Through diffusion, the wear resistant coating is atomically bonded to the surface of the substrate 50. The wear resistant coating may be bonded differently in an alternative embodiment, for example, chemically.

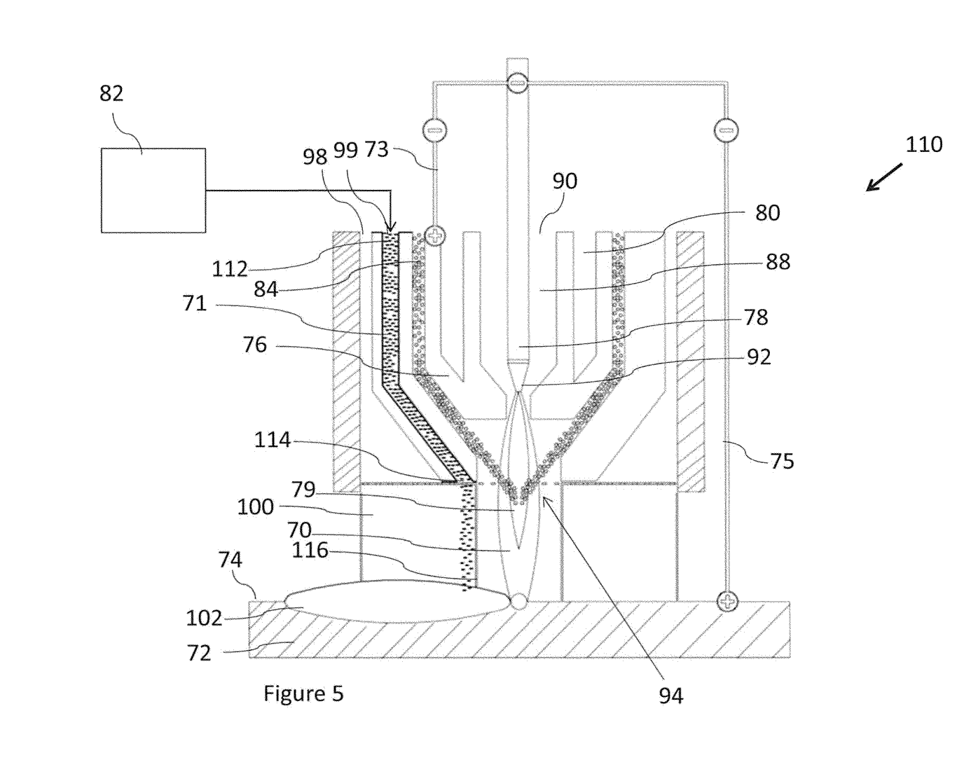

A wear resistance coating may be formed on a substrate using other embodiments of the method of FIG. 2. For example, a plasma transferred arc (PTA) surfacing process may be used. An example of a PTA torch 73 that may be used to form a wear resistant coating 102 is shown in FIG. 4. A gas (the “plasma gas”) is injected via a plasma gas inlet port 90 into an electrode chamber 88 within a nozzle 76 of the PTA torch 73. Disposed in the electrode chamber 88 is an electrode 78 in the form of a tungsten electrode. The plasma gas flows past the tip 92 of the electrode 78 whereat a current flows through the plasma gas to form the plasma stream 70 that exits via a nozzle outlet 94. The plasma stream 70 has a temperature that is, in this but not necessarily all examples, between 15,000 and 25,000 degrees centigrade. The plasma stream 70 is directed at the surface 74 of the substrate 72. The current is generated by applying a potential difference 75 to the substrate 72 and the electrode 78. Additionally or alternatively, another potential difference 77 between the electrode 78 and the nozzle 76 may be applied. The potential differences 73, 77 are generated by a power supply. One of the potential differences 73, 75 may not be applied. For example, potential difference 77 may be used to form a pilot arc 79 that may, in some but not necessarily all embodiments, be extinguished after establishment of the constricted plasma stream 70. The hardfacing powder 71 in the form of a mixture comprising the plurality of round particles and the wear resistant coating binder may be fed into the plasma stream 70 directed at the substrate 72. Generally any suitable hardfacing powder disclosed herein may be used. The hardfacing powder 71 together with a stream of powder carrier gas in the form of, for example, argon, is introduced or fed into a port 84 of the nozzle 76 by a powder feeder 82 and communicated along a passage to a hardfacing powder outlet 96 adjacent the nozzle outlet 94. The hardfacing powder outlet 96 is disposed for introducing the hardfacing powder 71 to the plasma stream 70 when so formed. The hardfacing powder so introduced into the plasma stream is heated and delivered by the plasma stream 70 to the surface 74 of the substrate 72 to form the wear resistant coating 102. The nozzle 76 also has an optional shielding gas inlet 98 and a shielding gas outlet 100 arranged to optionally deliver the shielding gas around the plasma stream 70 when formed. The shielding gas may prevent the work zone from being exposed to oxygen that may oxidise the surface 74, the wear resistant coating 102 or the torch 73.

The nozzle 76 is generally but not necessarily fluid cooled by a fluid in the form of water (or alternatively air or any generally suitable liquid) flowing through liquid chambers 80 formed in the nozzle 76.

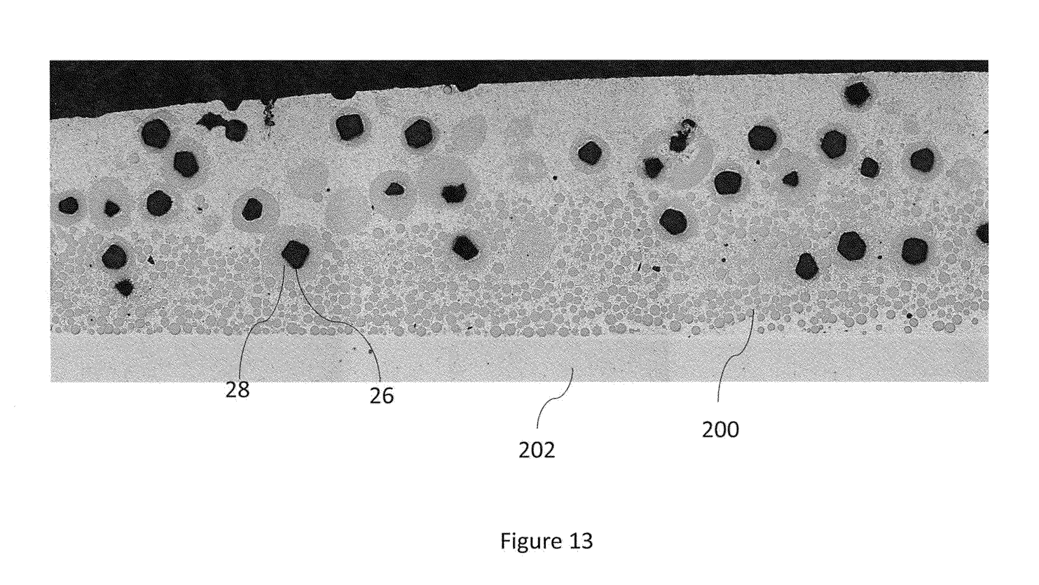

FIG. 5 shows another example of a PTA torch 110 that may be used to form a wear resistant coating 102. The PTA torch 110 is similar in form and function to the PTA torch 73 of FIG. 12, and parts of similar or identical form and/or function are similarly numbered. The PTA torch 110 of FIG. 13, however, is arranged such that the hardfacing power 71 is not introduced into the plasma stream 70 so formed. The hardfacing powder 71 together with a stream of powder carrier gas in the form of, for example, argon, is introduced or fed into a port 112 of the nozzle 76 by a powder feeder 82 and communicated along a passage to a hardfacing powder outlet 114 disposed for deposition of the hardfacing powder 71 on the surface 74 and outside of the plasma stream 70 when so formed. The hardfacing powder outlet 114 is a source of the hardfacing powder. The hardfacing powder may be applied, in other embodiments, by another source separate from the torch 110 or generally by any suitable source. The separate source may be strapped or otherwise fixed to the PTA torch 110, but not necessarily. In this embodiment, but not necessarily in all embodiments, the hardfacing powder outlet 114 is separated from the plasma stream nozzle outlet 94 by a separator in the form of a separating structure, in this embodiment a separating wall 116. In use, the PTA torch 110 is moved across the surface such that the hardfacing plasma outlet 114 follows the nozzle outlet 94. Consequently, the hardfacing powder 71 is deposited onto a plasma melted portion of the surface 74 to form the hardfacing. This may reduce the temperature that the hardfacing powder is exposed to, which may allow the use of hardfacing powders that may be otherwise degraded by heat from the plasma stream. There may be separate outlets for the plurality of wear resistant particles and the wear resistant coating binder.

The plasma stream heats the wear resistant coating binder and the plurality of round particles to a temperature greater than at least one of a wear resistant coating binder softening temperature and a wear resistant coating binder melting temperature. The wear resistant coating binder cools and hardens to bind the plurality of round particles.

Before application of the hardfacing powder 71 by one of the PTA surfacing processes described above, the surface 74 of the substrate 72 may be optionally cleaned by application of a grinder. Alternatively, a chemical cleaning agent, or generally any suitable cleaning process may be used. The substrate 72 may be steel or generally any substrate for which the method 12 is suitable. The surface may be preheated to 90-650 degrees centigrade prior to the PTA surfacing process by a resistive or inductive heater. Carbon and/or air quenched steels, for example, may be slow cooled after the PTA surfacing process.

In another embodiment, the plurality of round particles and wear resistant coating binder may be fed separately into the plasma stream directed at the substrate. For example, the wear resistant coating binder may be introduced into port 84 and the plurality of round particles into port 99.

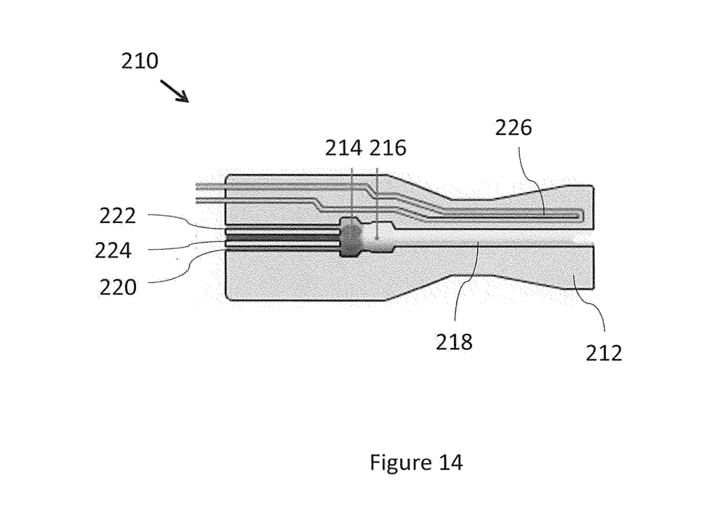

Generally any suitable process may be used to form the coating, for example high velocity oxy-fuel deposition (HVOF). An example of a HVOF torch (otherwise known as a HVOF gun) 210 is shown in FIG. 14. The torch 210 has a body 212 having a mixing chamber 214 and a combustion chamber 216 in communication with the mixing chamber. The torch 210 has a plurality of mixing chamber ports 220, 222 and 224. The torch 210 has a high-velocity jet passageway 218 that opens into the combustion chamber 216. Oxygen gas, a fuel in the form of oxyacetylene (or alternatively hydrogen, methane, propane, propylene, natural gas, kerosene, generally any suitable fuel or a mixture of these), and the hardfacing powder are introduced via the ports 220, 222 and 224 into the mixing chamber to form a mixture. The mixture passes into the combustion chamber 216 wherein the oxygen and fuel combust to form a high velocity gas jet in the form of a high velocity flame that carries the hardfacing powder along the high-velocity jet passageway 218. The high velocity flame may have, as in this embodiment, a velocity of greater than 1000 m/s. At a distal end of the high-velocity jet passageway is an outlet through which the high velocity gas jet and the hardfacing powder therein exits the torch 210. The high-velocity gas jet is directed at the substrate onto which the hardfacing powder is applied to form the wear resistant coating.

The substrate may generally be any suitable substrate, examples of which include, but are not limited to a drill bit used by the mining or another industry, other down-hole equipment, the teeth of a bucket for an excavator, a chisel, and a blade.

For the hardfacing powder 10 of FIG. 1, but not necessarily for all embodiments of a hardfacing powder, the round outer layer 28 has a density greater than that of the wear resistant element 26. The average density of the plurality of round particles 24 is greater than the average density of the wear resistant elements 26. Were the wear resistant elements naked or individual, then they may float upwards through the molten wear resistant coating binder during the coating process 12 resulting in an uneven concentration of wear resistant elements in the wear resistant coating, which is generally undesirable. In the present embodiment, the wear resistant coating binder penetrates the round outer layers, reducing the buoyancy of the plurality of round particles.

In this embodiment, the round outer layer is a composite in the form of a cermet, with a theoretical density generally in the range of 15 g·cm⁻³. The cermet comprises comprise cobalt. Cobalt has a density of around 8.9 g·cm⁻³. The wear resistant element is a diamond, which has a density of around 3.5 g·cm⁻³.

The plurality of metallic particles may, for example, comprise any suitable brazing metal, example of which include copper, tin, silver, cobalt, nickel, cadmium, manganese, zinc or an alloy thereof. The metallic particles may also comprise chromium that hardens the alloy formed on solidification of the molten hardfacing powder. The wear resistant coating binder may also contain silicon and/or boron powder to aid in fluxing and deposition characteristics. In the present embodiment, the plurality of metallic particles comprise nickel, chromium, boron and silicon. Nickel may constitute 88%-95% by weight, chromium may constitute 0-12%, boron may constitute 0%-1% and silicon may constitute 0%-1%.

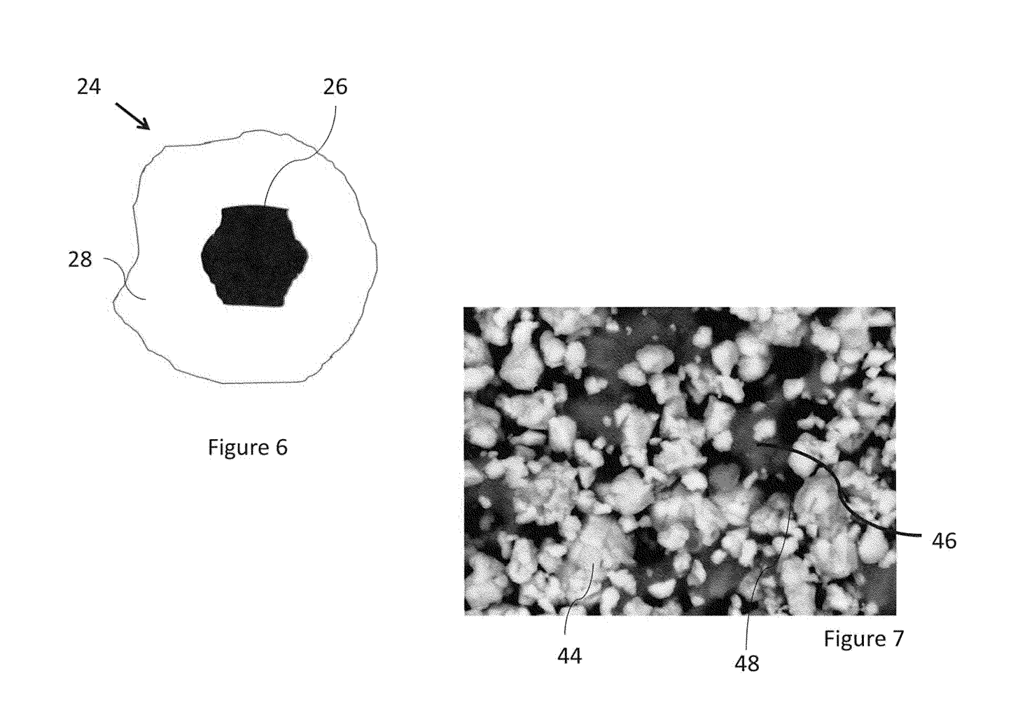

FIG. 6 shows a cross section of a representative particle 24 of the plurality of round particles, the wear resistant element being indicated by the numeral 26 and the round outer layer (“encapsulant”) being indicated by the numeral 28. The wear resistant element 26 is in this embodiment a super hard material, which is conventionally understood to be a material having a Vickers hardness of greater than 40 GPa. Examples of super hard materials that may be used include but are not limited to synthetic diamond, natural diamond and cubic boron nitride. However, alternative embodiments do not have elements comprising super hard material. The element in this embodiment has an indentation resistance of greater than 20 GPa and an elastic modulus of greater than 200 GPa. The element may be crystalline or polycrystalline. Other examples of suitable wear resistant element materials include silicon reacted polycrystalline diamond, catalyst-free polycrystalline diamond, alumina, partially stabilized zirconia, silicon carbide and silicon nitride. Generally, but not necessarily, wear resistant elements with a Vickers hardness exceeding 20 GPa may be used. The element 26, in this but not in all embodiments, is synthetic diamond. The element typically has a relatively low density of less than 6 g·cm⁻³.

In this but not necessarily in all embodiments, the round outer layer 28 comprises a polycrystalline cermet in the form of tungsten carbide particles sintered with cobalt particles. A cermet is generally a composite material composed of ceramic particles (for example an oxide, boride or carbide) bound together with a metallic material (examples of which include nickel, molybdenum and cobalt). The encapsulant 28 differs from the wear resistant element 26 in that, in this but not necessarily in all embodiments, it is of a lower hardness. The encapsulant is, in this but not necessarily in all embodiments, polycrystalline and prior to its fabrication into the hardfacing powder may be present in different forms such as having unreacted and un-bonded adjacent grains through to fully sintered with low-to-no measurable porosity. Alternatively, the round outer layer 28 may comprise a metal matrix composite, for example polycrystalline tungsten or molybdenum in a metal binder such as cobalt, nickel or iron.

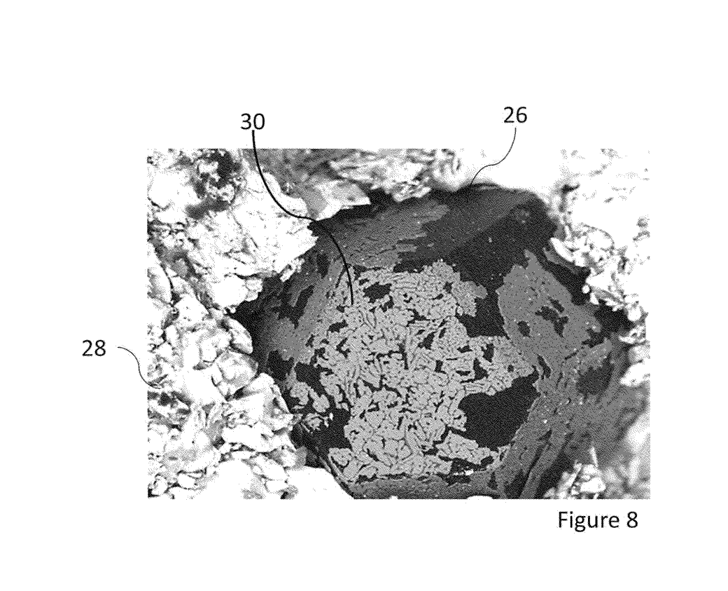

FIG. 7 is a Back Scattered Scanning Electron Micrograph of the encapsulant 28. In this micrograph the polycrystalline material, in this case tungsten carbide 44 has sintered and bonded neighboring grains. A sintering aid material, in this case cobalt 46 has partly softened by heating during the formation of the plurality of round particles to form the encapsulant or pellet and in so doing has ‘bridged’ and joined to itself and the polycrystalline material 44. In this particular example the structure is not fully densified and of voids or holes 48 are present within the structure. A semi-porous structure, with small pores and high-capillary forces may be advantageous in terms of metallurgical bonding during the brazing process. Density levels of the material used to form the grains within the encapsulant are higher than the super hard element (>6 g·cm⁻³). The overall density and hardness of the encapsulant is dependent on the material used and the degree of sintering. Independent of the degree of sintering, the encapsulant significantly increases the density of the plurality of round particles. In the case where sintering is required, metals may be used in powder form as an aid to sintering. Examples of the materials used within the polycrystalline material include but are not limited to tungsten and tungsten carbide. Examples of the sintering aids that may be used include but are not limited to cobalt, nickel and iron. Methods used to encapsulate the elements within the encapsulant generally, but not necessarily promote high degrees of sphericity, even when the wear resistant elements are not round or not spherical in nature, for example cuboid, acicular or elliptical. The majority of pellets used (>50%) contain one wear resistant element. The majority (>50%) of the wear resistant elements will be encapsulated within the encapsulant, so there may be a minority of examples (<50%) where the wear resistant element is not encapsulated by the encapsulant at all.

The element 26 is, in this but not in all embodiments, metallurgically bonded to a coating intermediate of the element 26 and the encapsulating material 28. The coating may be deposited using different techniques, including but not limited to chemical vapor deposition, physical vapor deposition and metallization. Such techniques provide a coating that is generally of the order of one to a few microns thick; e.g. 1-2 microns. Examples of coating materials include but are not limited to titanium and silicon where the element 26 is a diamond.

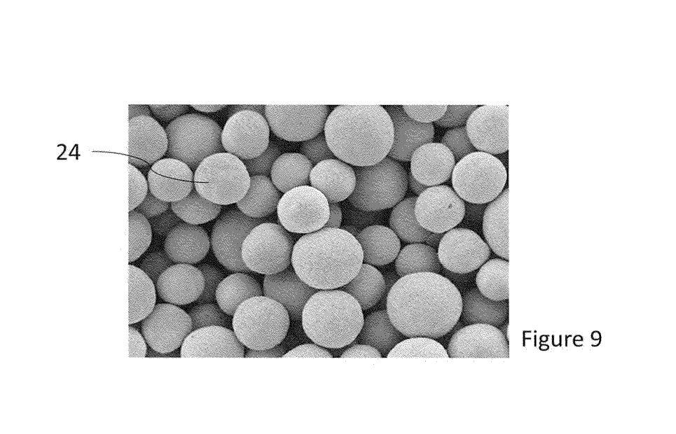

FIG. 8 is a Back Scattered Scanning Electron Micrograph of a fracture through the particle 24. The revealed coating 30 intermediate of the elements 26 and the encapsulation material is, in this but not necessarily in all embodiments, a metallic coating comprising titanium. In the micrograph of FIG. 8, the titanium 30 that was originally completely surrounding and bonded to the element 26 has been partly removed on fracture. The opposing fracture surface or pocket (not shown) contains remnants of the titanium, indicating equivalent metallurgical bonding between the titanium and the element, and the titanium and the encapsulant. The volume of the coating is much less (generally but not necessarily less than 1/100) of that of the element 26. The effect of the coating 30 does not, in this but not necessarily all embodiments, significantly contribute to the overall density of the element 26. The coating 30 may provide for a stronger bond between the element 26 and the encapsulating material 28, together with thermal and chemical protection of the element 26 during the manufacture and use of the hardfacing powder.

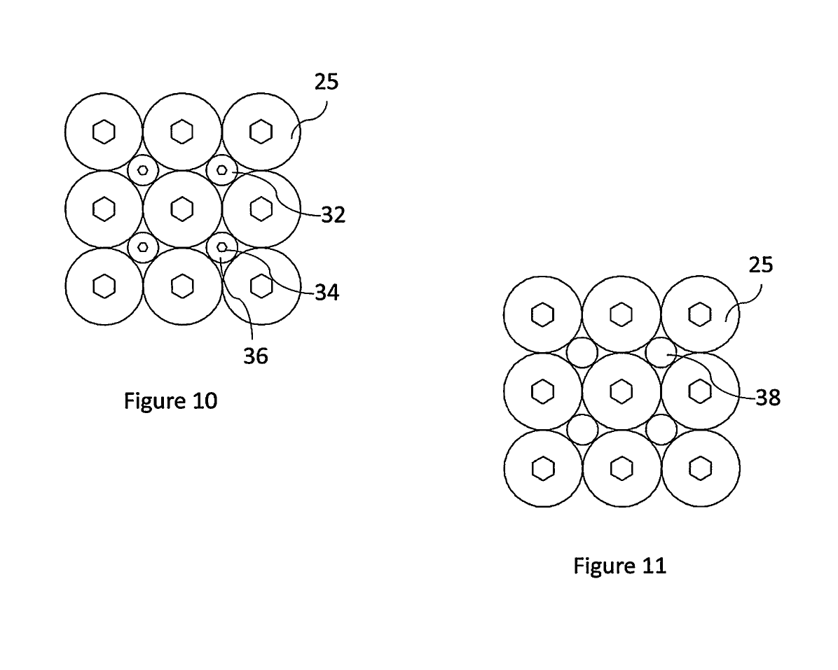

FIG. 9 shows a plurality of round particles. A majority of the plurality of round particles 24 in this but not necessarily in all embodiments each have a diameter of between 70% and 130% of a mean diameter of the plurality of round particles. In other embodiments, the majority of the plurality of round particles may each have a diameter of between 80% and 120% of a mean diameter of the plurality of round particles. In yet other embodiments, the majority of the plurality of round particles may each have a diameter of between 90% and 110% of a mean diameter of the plurality of round particles. In still yet other embodiments, the majority of the plurality of round particles may each have a diameter of between 95% and 105% of a mean diameter of the plurality of round particles. The applicants are of the opinion that the narrower the distribution of diameters the less defects a close packed structure of the plurality of round particles will have and the better the performance of the wear resistant coating. A bulk material or powder (hereafter referred to as “powder”) comprising a plurality of round particles having a narrow distribution of diameters may, however, be relatively more expensive to produce.

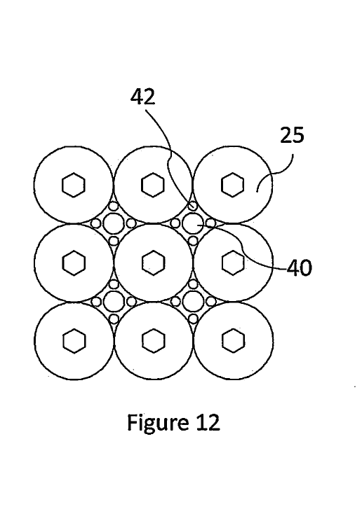

FIG. 10 shows a schematic diagram where the interstices of a plurality of round particles 25 in a hardfacing powder (or wear resistant coating formed using the hardfacing powder), are occupied with another plurality of particles, such as 32. Each of the other plurality of particles has an element 34 of super hard material encapsulated by an encapsulant 36, as described herein in respect to the plurality of particles.

FIG. 11 shows a schematic diagram where the interstices of a plurality of round particles, such as 25, in a hardfacing powder (or wear resistant coating formed using the hardfacing powder) are occupied by the other plurality of particles, such as 38, which do not have an encapsulant. In this case but not necessarily in all cases, the other plurality of particles are harder than the encapsulant.

FIG. 12 shows a schematic diagram where the interstices of a plurality of round particles, such as 25, are occupied by the other plurality of particles which comprise a first plurality of particles, such as particle 40, having a first mean diameter and a second plurality of particles, such as particle 42, having a second mean diameter that is less than the first mean diameter. The second mean diameter is in this, but not all embodiments are less than 10% of the first mean diameter. The plurality of particles is within a hardfacing powder or a wear resistant coating formed using the hardfacing powder. The inclusion of the second plurality of particles may result in better closure of the interstices. In one example, the plurality of round particles have a mean diameter of 0.333 mm, the first plurality of particles (primary interstitial particles) have a mean diameter of 0.098 mm and the second plurality of particles (secondary interstitial particles) have a mean diameter of 0.008 mm. The other plurality of particles may comprise a third plurality of particles (tertiary interstitial particles) that may have a mean diameter that is less than the second mean diameter, say 0.001 mm.

The other plurality of particles may be constructed from different materials such as diamond, tungsten carbide, tungsten, alumina, silicon carbide and silicon nitride or generally any suitable material. Their size and distribution may be selected to maximize the packing density and wear behavior when deposited within the hard facing consumable. In this embodiment, they are tungsten carbide.

In the FIGS. 10 to 12, the plurality of round particles have a close packed arrangement. Because the particles are round they are able to adopt a close packed arrangement that may be denser than other packing arrangements. Consequently, the number of elements per unit volume may be greater than for hardfacing powders and wear resistant coatings having particles that are not in a close packed arrangement. Increasing the number of elements per unit volume generally improves the coatings wear resistance. Close packing may improve the capillary action that moves the molten wear resistant coating binder (for example a braze material or metal) through the plurality of round particles during binding in which the braze material infiltrates the interstices between the plurality of round particles. Consequently, close packing may provide relatively high structural integrity by relatively better joining of the plurality of round particles and largely avoid defects that may be encountered in brazed material systems caused by inter-particle distances that are too big. Perfect close packed arrangements—generally a face centered cubic arrangement, but in some embodiments a hexagonal close packed arrangement—may be achieved when the plurality of round particles are identical perfect spheres. The close packed arrangement of the plurality of round particles will generally but not necessarily have defects because the plurality of round particles generally deviate from perfect spheres and have various sizes. Nevertheless, the benefits provided by a defective close packed arrangement of the plurality of round particles may approach those of a perfect close packed arrangement.

In this but not necessarily in all embodiments, the volume fraction of the plurality of round particles is at least 0.05 and no more than 0.85. The wear resistant element of each of the plurality of round particles has, in this embodiment, an ISO 6106 mesh size of at least 18 and no more than 120. In an alternative embodiment, the wear resistant elements of each of the plurality of round particles may have an ISO 6106 mesh size of no more than 80. ISO stands for the International Standards Organization, and documents describing standard 6106 are publically available.

In an embodiment of a method for making the hardfacing powder 10, the plurality of round particles and the wear resistant coating binder are combined. This may comprise, for example, disposing the plurality of round particles and the wear resistant coating binder in a mixer or blender, for example an industrial blade mixer, turbola or a blender that executes a cone blending process.

The wear resistant coating binder may take the form of, for example, a powder comprising at least one of nickel, cobalt, tungsten carbide, chromium, and a fluxing agent. Fluxing agents may be self fluxing and/or chemical fluxing agents. Examples of self fluxing agents including silicon and boron, while chemical fluxing materials may be based on borates. In this embodiment, however, a fluxing agent and deoxidizer in the form of silicomanganese 2% Carbon (ELKEM CHEMICALS or CHEMALLOY) is added to the mixture. To form the mixture, the plurality of round particles, the wear resistant coating binder, the fugitive binder, and other particles as used including the other plurality of particles, may be mixed in an industrial blade mixer, tumbled in a tumble mixer, or generally mixed using any suitable mixing method.

FIG. 13 shows a micrograph of an embodiment of a wear resistant coating 200 that may be formed on a substrate 202 using the powder. The wear resistant coating binder is, in this embodiment but not necessarily in all embodiments, wholly melted during application of the hardfacing powder. The wholly melted wear resistant coating binder penetrates a plurality of interstices between the plurality of round particles and on cooling forms a matrix in the form of a monolithic matrix that binds the plurality of round particles. The filling of interstices by the binding material improves the strength of the resulting composite and consequently the robustness of the wear resistant coating. The binding material may also, as in this embodiment, form a metallurgical bond with any interstitial particles that may be included.

The round outer layer of each of the plurality of round particles generally may comprise a porous or skeletal structure, in which internal surfaces define internal voids and/or passageways. The binding material penetrates the porous or skeletal structure, and may fill the internal voids and/or passageways, to form a web within the round outer layer of at least a majority of the plurality of round particles. This results in a strong mechanical attachment to the plurality of round particles. The binding material penetrates to the coating 30 intermediate of the elements 26 and the encapsulating material 28.

In the wear resistant coating when formed, the binding material may, as in the present embodiment, penetrate to the coating 30 intermediate of the elements 26 and the encapsulating material. The binding material is metallurgically bonded with the coating 30 intermediate of the element 26 and encapsulating material 28. Consequently, the wear resistant elements, in this embodiment diamonds, are metallurgically bonded to the wear resistant binder by way of the intermediate coating 30. This may generally improve the attachment of the wear resistant elements, especially when they are exposed by wear and mere mechanical attachment may be insufficient for their retention in the wear resistant coating. This may improve the wear resistant coating's performance and life.

The solidified wear resistant coating binder is, in this but not necessarily in all embodiments, also metallurgically bonded to the plurality of round particles (which may comprise metal), at the outer surfaces of the plurality of round particles, and at internal surfaces of the plurality of round particles. This may further increase the strength of the final wear resistant coating.

The metallurgical bonds disclosed herein may comprise diffused atoms and/or atomic interactions. Under such conditions, the component parts may be “wetted” to and by the binding material.

### Fabrication of the Plurality of Round Particles

An example method for the fabrication of examples of the plurality of round particles will now be described. Generally, any suitable method for fabricating the plurality of round particles may be used. A mixture of tungsten carbide powder having a Fisher sub sieve size of 1 μm and cobalt powder having a Fisher sub sieve size of 1.2 μm were mixed 50/50 by weight. Alternatively or additionally to cobalt, any suitable metal powder, for example a powder comprising at least one of Nickel, copper, and alloys thereof. MBS955 Si2 40/50 mesh diamonds are tumbled in the mixture of tungsten carbide powder and cobalt powder with a binding agent in the form of methyl cellulose while controlled amounts of water is simultaneously sprayed thereon. Each diamond is coated to form the plurality of round particles in a green state. The plurality of round particles in the green state may then be heated in a Borel furnace under a protective hydrogen atmosphere. The plurality of round particles in the green state may be heated around room temperature to 500° C. over an hour approximately. The plurality of round particles are maintained at 500° C. for around 30 min. The temperature is then elevated to 850° C. over around 180 min. The sintered plurality of round particles are allowed to cool.

### Applications

The hardfacing powder 10 may be used to form a wear resistant coating on any suitable substrate. Some suggested applications are now described, however it will be appreciated that there are many applications of the wear resistant coating.

Stabilizers are used in the exploration and production of oil and gas. Their function is to provide stability to the drill bit and maintain dimensional control of the hole. Large sections of the stabilizer are in direct contact with the walls of the hole or steel casing. Through rotation of the drill string and progressive drilling, protective elements and hard facings are prone to wear which may eventually result in repair, end-of-life or dimensionally unacceptable diameters. Stabilizes having a wear resistant coatings described herein applied thereto may reduce or eliminate these issues.

Rotary bi- and tri-cone drill bits are manufactured with protrusions or “teeth” that are machined from parent steel. A drill bit having a wear resistant coating described herein applied thereto may have increased life and exhibit reduced “teeth” wear, which may increase drilling performance and productivity.

During mechanical excavation and removal of rock, significant wear can be seen on excavator teeth and buckets. Excavator teeth and buckets having a wear resistant coating described herein applied thereto may have prolonged life and consequently replacement costs may be reduced.

The outside diameter of a polycrystalline diamond drill bit is subject to sliding wear. A polycrystalline drill bit having a wear resistant coating described herein applied thereto may have an increased serviceable life.

During the life of a polycrystalline diamond drill bit the body and blades of the bit that support the cutting structure may be subject to life-limiting wear. Bodies and blades having a wear resistant coating described herein applied thereto may reduce erosive wear, which may increasing tool life and reduce costs.

Picks are used during the mechanical excavation of rock and the surface dressing of road surfaces. A pick is manufactured generally in two-pieces; body and insert. The body is conventionally steel and the insert commonly cemented carbide. In some circumstances diamond containing inserts are used. Body life is generally limited by excessive wear or “Wash”. A body having a wear resistant coating as described herein and in close proximity to the insert may have prolonged life, and reduce down time required for replacing worn picks.

Crusher teeth may be used in various applications including in the mechanical extraction of oil from oil containing sand. The crusher teeth may be positioned around a rotating drum and mechanically interact with the rock, sand and oil. Wear may be great. Crusher teeth having a wear resistant coating as described herein applied thereto may have prolonged life.

In the context of gas and oil drilling, a mud-powered motor drives bit rotation and torque. The motor may contain both radial and axial bearings that are in sliding contact with opposing bearings or rolling elements. A bearing having a wear resistant coating as described herein applied thereto may significantly increase bearing life, reduce bearing length and offer the ability for more sets of bearings that promote higher bit-weights and better productivity when drilling for oil and gas.

Now that embodiments have been described, it will be appreciated that some embodiments may have some of the following advantages:
Wear resistant elements may have a relatively low density. Consequently, in the prior art, the wear resistant elements may be poorly distributed in the wear resistant coating and may be in close proximity to one another, or even touching which may weaken the structure because infiltration may be reduced. Thin coatings onto a super hard material may not fully overcome these density differences or avoid part-to-part contact. Encapsulation of the wear resistant elements and penetration of the round outer layer by the binding material) may ameliorate these problems.
The round nature of the encapsulant and/or careful selection of sizes and shapes of interstices occupying particles promotes high packing and further optimizes wear resistance.
The structure of the encapsulant may be either an open or closed structure. An open semi-porous topography may provide high surface area and strong capillary forces for reaction and infiltration.
During cooling and solidification of the molten wear resistant coating binder, the encapsulated wear resistant elements may be placed under compression by the encapsulant, providing improved retention and better wear properties.
The liquid metal infiltration of the encapsulant during the coating process and subsequent solidification may provide a mechanically improved compressive stress that holds and bonds the wear resistant elements in. This advantage may not be enjoyed by non-encapsulated super hard elements.
The wear resistant elements may be metallurgically bonded to the wear resistant binder by way of the intermediate coating 30. This may improve the attachment of the wear resistant elements and the wear resistant coating's performance and life.

The wear resistant elements discussed herein may have significantly increased hardness and wear resistance compared to tungsten carbide based metal matrices formed by conventional hardfacing materials. Variations and/or modifications may be made to the embodiments described without departing from the spirit or ambit of the invention. For example, while the substrate disclosed above is steel, it will be appreciated that embodiments may be used on other substrate materials, for example another metal such as aluminum, a cemented carbide, or generally any suitable substrate material. The powder may be poured or otherwise applied onto the substrate. The powder may be fused by heating the substrate and powder thereon in a furnace. The present embodiments are, therefore, to be considered in all respects as illustrative and not restrictive.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. A method of forming a wear resistant coating on a substrate, the method comprising the steps of:
applying a plurality of round particles to the substrate, each of the plurality of round particles comprising a round outer layer encapsulating a wear resistant element;
applying a wear resistant coating binder to the substrate; and
heating the plurality of round particles and the wear resistant coating binder.

2. A method defined by claim 1, further comprising the step of metallurgically bonding the wear resistant coating binder to at least one of an inner surface and an outer surface of the round outer layer of each of the plurality of round particles.

3. A method defined by claim 1, wherein the wear resistant coating binder comprising metallic binding material and the metallic binding material is melted to form a monolithic matrix of metallic binding material.

4. A method defined by claim 3, further comprising the step of the metallic binding material so melted penetrating the round outer layer of each of the plurality of round particles.

5. A method defined by claim 3, wherein the wear resistant element of each of the plurality of round particles has a coating metallurgically bonded thereto and comprising the step of metallurgically bonding the coating of each of the plurality of round particles with the wear resistant coating binder.

6. A method defined by claim 1, wherein the step of applying the plurality of round particles to the substrate comprises the step of introducing the plurality of round particles into a flame directed at the substrate, the flame heating the plurality of round particles.

7. A method defined by claim 6, wherein the step of applying a wear resistant coating binder to the substrate comprises the step of introducing the wear resistant coating binder into the flame directed at the substrate, the flame heating the wear resistant coating binder.

8. A method defined by claim 6, comprising the step of introducing a mixture comprising the plurality of round particles and the wear resistant coating binder into a flame directed at the substrate, the flame heating the plurality of round particles and the wear resistant coating binder.

9. A method defined by claim 8, wherein the flame heats the plurality of round particles and the wear resistant coating binder above an adhesion temperature.

10. A method defined by claim 1, further comprising applying the plurality of round particles and a wear resistant coating binder to the substrate by introducing the plurality of round particles and the wear resistant coating binder into a plasma stream directed at the substrate, the plasma stream heating the wear resistant coating binder and the plurality of round particles.

11. A method defined by claim 10, wherein the plasma stream heats the wear resistance coating binder to a temperature greater than at least one of a wear resistant coating binder softening temperature and a wear resistant coating binder melting temperature.

12. A method defined by claim 10, further comprising the step of introducing a mixture comprising the plurality of round particles and the wear resistant coating binder into a plasma stream directed at the substrate.

13. A method defined by claim 10, further comprising the step of introducing the plurality of round particles and the wear resistant coating binder separately into a plasma stream directed at the substrate.

14. A method defined by claim 1, wherein the plurality of round particles and the wear resistant coating binder are deposited onto a melted portion of the substrate outside of a plasma stream that heated the melted portion, the melted portion of the substrate heating the plurality of round particles and the wear resistant coating binder.

15. A method defined by claim 14, wherein the melted portion of the substrate heats the wear resistant coating binder to a temperature greater than at least one of a wear resistant coating binder softening temperature and a wear resistant coating binder melting temperature.

16. A method defined by claim 14, wherein the plurality of round particles and the wear resistant coating binder are separated from the plasma stream by a separator.

17. A method defined by claim 14, wherein the plasma stream is moved across a surface of the substrate and a source of the plurality of round particles and a source of the wear resistant coating binder follow the plasma stream.

18. A method defined by claim 14, wherein the plasma stream is moved across a surface of the substrate and a source of the plurality of round particles and the wear resistant coating binder follow the plasma stream.

19. A method defined by claim 14, further comprising the step of delivering a shielding gas around the plasma stream.

20. A method defined by claim 6, wherein the flame is generated by a high velocity oxygen-fuel deposition torch.

21. A wear resistant coating on a substrate, the wear resistant coating comprising:
a composite material comprising a plurality of round particles bound together by a wear resistant coating binder, wherein each of the plurality of round particles comprises a round outer layer encapsulating a wear resistant element, the wear resistant coating binder penetrates the round outer layer and is metallurgically bonded to a coating metallurgically bonded to the wear resistant element of each of the plurality of particles, wherein the wear resistant coating binder is metallurgically bonded to at least one of an inner surface and an outer surface of the round outer layer of each of the plurality of round particles.

22. A hardfacing powder for forming a wear resistant coating on a substrate, the hardfacing powder comprising a plurality of round particles, and a wear resistant coating binder for binding the plurality of round particles in the wear resistant coating when formed, wherein each of the plurality of round particles comprises a round outer layer encapsulating a wear resistant element.
